(19) United States
(12) Patent Application Publication
(10) Pub. No.: US 2014/0305579 A1
(43) Pub. Date: Oct. 16, 2014

(54) DECOUPAGE METHOD

(71) Applicant: Toshie Matsunaga, New York, NY (US)

(72) Inventor: Toshie MATSUNAGA, New York, NY (US)

(21) Appl. No.: 14/250,205

(22) Filed: Apr. 10, 2014

Related U.S. Application Data
(60) Provisional application No. 61/810,333, filed on Apr. 10, 2013.

(30) Foreign Application Priority Data
Apr. 10, 2013 (JP) 2013-82123

(51) Int. Cl. B44C 3/12

(52) U.S. Cl. CPC B44C 3/12
USPC 156/249

(57) ABSTRACT

Treatment is difficult when using standard photographs due to issues such as thickness, and in the method utilizing a transfer solution, although it is possible to extract a motif in the form of a thin film, there exists the problem of the work being laborious. A decoupage method is provided which comprises the steps of (a) printing a motif using sublimation thermal transfer printing on photographic printing paper having a thin-film image-receiving layer on the surface, (b) separating only the thin-film image-receiving layer on which the motif is printed from the photographic printing paper as a thin-film image-receiving layer sheet, (c) adhering the separated thin-film image-receiving layer sheet to the surface of a object, and (d) finishing the surface of the object to which the thin-film image-receiving layer sheet is adhered.

### CROSS REFERENCE TO RELATED APPLICATIONS

This application claims priority under 35 U.S.C. 119 based upon Provisional Application Ser. No. 61/810,333, filed on Apr. 10, 2013. The entire disclosures of the aforesaid applications are incorporated herein by reference.

### FIELD OF THE INVENTION

The present invention relates to a novel decoupage method. In particular, the invention relates to a decoupage method that enables improvements in the applicability of standard printed photographs as a motif, to a material to be decoupaged, and in decorative value.

### BACKGROUND OF THE INVENTION

(Decoupage)

Decoupage is widely-known as a kind of handicraft.

As the word “decoupage” is derived from the French word “decouper (cut out),” decoupaging is a decorative technique of cutting out motifs such as pictures and patterns printed on paper, fabric, etc., and after pasting the cutouts on a material such as a box or a plate, smoothly finishing the surface of the material to make the motif become integral part of the surface. Decoupage is highly popular as handicraft for decorating materials, since performing easy, high-level decorating is possible simply by transferring an existing pattern or picture to a material by means of decoupage.

Conventional decoupage, as a method of using photographs as a material, is roughly divided into two methods.

(Conventional Method 1: The Method of Pasting Photo Paper without Altering.)

The first method is a method of pasting a motif printed on paper or fabric without being altered on a material, and then coating a material with a coating solution. This method has the advantage of being extremely simple to carry out. However, because a significant height difference may be formed between the material and the motif, depending on the type of paper or fabric that the motif is printed on, there are cases when the use of relatively thin paper or fabric is necessary. For example, if a hard or thick material such as standard photo paper is used, it is necessary to apply a thicker layer of coating than would be needed otherwise in order to eliminate the height difference between the borders of the photo element and the material.

Conventional Method 2: The Method of Using a Transfer Solution.

The second method employs a transfer solution. In this method, the step of applying a transfer solution to a material and allowing the solution to dry is repeated several times until only a pattern or a picture, which constitutes the motif, is transferred from the paper or fabric, producing a thin film (film) that this method utilizes. The problem explained in the above-mentioned first method is non-existent since the film produced by means of this method is thin. However, the step of forming the film is intricate and time-consuming since it is necessary to repeat the step of coating the material with the transfer solution and allowing the transfer solution to dry. Furthermore, since the thickness of the film, to which a pattern from a material is transferred, varies depending on the number of times that the transfer solution is coated and dried, it is difficult to produce a film having uniform thickness optimal for adhesion. In the method of using a transfer solution, after the step of coating and drying the transfer solution, the material which was coated with the transfer solution is scraped off from the back side of the film to separate the film from the material. Thus, if the produced film is too thin, there exists the problem of the film being torn during the step of separating the film. Moreover, if the produced film is too thick, the final finish becomes stiff and appearance is impaired.

Furthermore, significant disadvantages exist in the method of extracting an image using the transfer solution. For example, the image is reversed and writing, especially, becomes a mirror image. In the case of photographs printed in three colors of ink, the color white becomes transparent such that white color in the photograph is not visible if pasted on a color other than white, and since the transferred image is thin and transparent, the base color shows through the entirety of the image. Moreover, the image quality of the transferred image is reduced in comparison to the original photograph.

### SUMMARY OF THE INVENTION

As described above, in the method of extracting a motif from a material using decoupage, treatment is difficult when using standard photographs due to issues such as thickness. Meanwhile, in the method utilizing a transfer solution, although it is possible to extract a motif in the form of a thin film, there exist the problems of the work being laborious, extraction being difficult such that the quality of the photograph decreases, writing becomes a mirror image, the color white becomes transparent when there are three different colors of ink, and the base color shows through the entirety of the image since the transferred image is thin and transparent.

Furthermore, the method is not suited for practical use when decoupaging material such as leather or synthetic leather, since the material feels hard and stiff after curing when a standard coating agent is used. Moreover, since soft-curing type coating agents for fabric and paper napkins have weak adhesive power, application is limited to fibrous materials such as fabric and paper napkins. As a result, decoupaging supple leather or synthetic leather had been difficult.

Accordingly, the purpose of the present invention is to eliminate the deficiencies of the abovementioned prior art, to enable the minimization of height differences, and to provide a highly workable and applicable decoupage.

In order to resolve the abovementioned issues, the inventor of the present invention conducted diligent research into techniques for relatively easily extracting motifs from materials, in a state which is easy to treat, and as a resulted of the research, they obtained the knowledge associated with the present invention. Then, through using that knowledge on all types of motif materials, and application objects, and repeating experiments, the present invention was accomplished.

According to a decoupage method of the present invention, a decoupage method of adhering a motif to the surface of an object to decorate the object is provided. The method comprises the steps of: (a) printing a motif using sublimation thermal transfer printing on photographic printing paper having a thin-film image-receiving layer on the surface; (b) separating only the thin-film image-receiving layer on which the motif is printed from the photographic printing paper as a thin-film image-receiving layer sheet; (c) adhering the separated thin-film image-receiving layer sheet to the surface of an object; and (d) finishing the surface of the object to which the thin-film image-receiving layer sheet is adhered.

According to one embodiment of the present invention, the thin-film image-receiving layer sheet preferably comprises a thermoelastic polyester resin.

Further, the step (c) preferably comprises applying a glue to the rear surface of the thin-film image-receiving layer sheet and drying the glue; and positioning the thin-film image-receiving layer sheet in relation to the object to apply heat over the surface of the thin-film image-receiving layer sheet whereby the thin-film image-receiving layer sheet is closely pressed along the surface of the object to cause the glue to become viscous and adhere to the object.

The object may be a felt material, and if it is the case, the step (d) comprises coloring the surface of the object to which the thin-film image-receiving layer sheet is adhered; and forming an irregular texture on the surface of the object to which the thin-film image-receiving layer sheet is adhered, whereby an synthetic leather-like texture is provided to the surface of the object.

The object may be a leather material or an synthetic leather material, and if it is the case, the step (d) comprises coating the surface of the object to which the thin-film image-receiving layer sheet is adhered with a coating agent; and after the coating agent is dried, placing a Teflon® sheet on the coated surface of the object to apply heat and pressure by a thermo-pressure means to the coated surface through the Teflon® sheet, whereby the coating agent is bonded to the object through thermo-compression bonding. According to this method, it is possible to process leather or a synthetic leather material. Furthermore, the object to which the coating agent is bonded through thermo-compression bonding may be a leather product or a synthetic leather product.

According to the abovementioned decoupage method, it is possible to obtain the effect of being able to decoupage a printable motif of choice on a desired location, without compromising the appearance.

Other characteristics of the present invention, which were not mentioned above, will be clear to a person skilled in the art based on the descriptions of embodiments of the present invention which will be discussed below.

### BRIEF DESCRIPTION OF THE DRAWINGS

FIG. 1 shows the layered structure of the photographic printing paper which has a surface film layer upon which the material to be decoupaged is printed.

FIG. 2 is a flow chart indicating the decoupage creation process in the method of one embodiment of the present invention.

FIG. 3 is a flow chart indicating the decoupage creation process in the method of another embodiment of the present invention.

### DETAILED DESCRIPTION OF THE INVENTION

Below, one embodiment of the present invention is explained with reference to the figures.

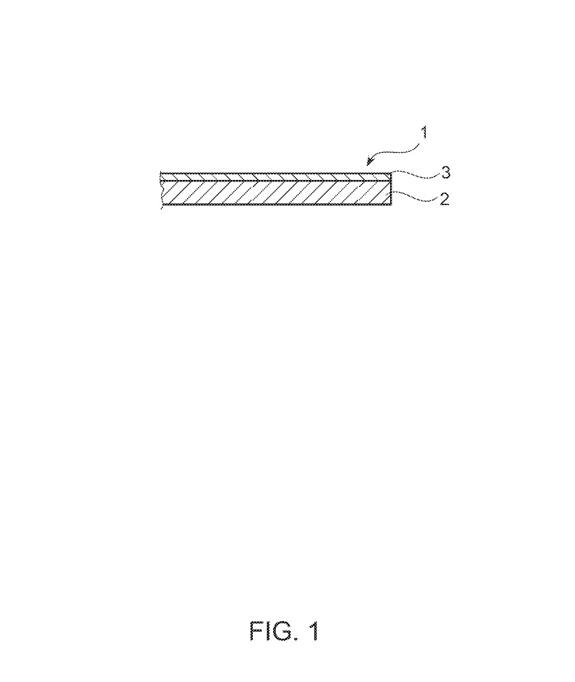

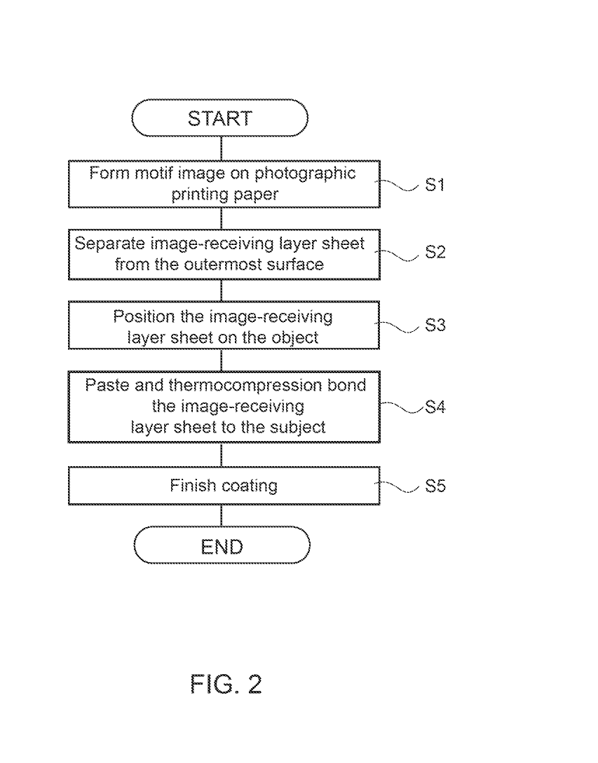

FIG. 1 is a schematic diagram indicating the photographic printing paper (1) used in the decoupage method of this embodiment. FIG. 2 is a flow chart indicating each step (S1-S5) of the decoupage method of the embodiment.

First, an image to be used for a motif is formed on the photographic printing paper (1). This step of forming the image is done by printing the image created by image editing software or illustrating software on a computer using a sublimation thermal transfer printer.

In standard image printing methods, there is an ink recording system and a heat transfer recording system, and the method used in this embodiment is a method in the heat transfer recording system known as a sublimation thermal transfer system. In order to form an image using the sublimation thermal transfer system, a photographic printing paper (1) wherein an image-receiving layer sheet (3) is formed on a base sheet (2) is used in this embodiment. The base sheet (2) has a configuration wherein, for example, both sides of the paper core are layered with foam polyolefin layers, and the image-receiving layer sheet (3) comprises a thermoelastic polyester resin which has a high affinity for dispersion dyes. In this embodiment, the image-receiving layer sheet (3), as is explained hereafter, is separated from the base sheet (2) after printing, and a supplemental material, such as silicon or fluorine-based resin may be added in order to reduce the possibility of heat-adhesion of the image-receiving layer sheet in the base sheet and increase peeling properties of the image-receiving layer sheet.

In this step, an image is formed using the abovementioned heat-sensitive sublimation thermal transfer printer, by controlling and transferring the dye of a printer ribbon sublimation dye layer (4) to a heat-transfer image-receiving sheet (5). Since the coloring material is dye, transparency is excellent, the formed image is extremely clear, and as the reproducibility of halftones and gradation are excellent, a very high-definition image is obtained, such that high-quality images comparable to full-color, silver-halide photographs can be obtained.

Next, in step S2, the image-receiving layer sheet (3) (thermoelastic sheet) comprising the printed motif is separated from the base sheet (2). Although not necessarily limited to the following, the separation of the image-receiving layer sheet in this step is performed by inserting a thin separation tool in between the base sheet (2) and the image-receiving layer sheet (3) of the photographic printing paper (1), and by moving the tool in parallel along the base sheet (2). In the event that the paper element is sticking and cannot be separated only using the separation tool, it is possible to completely scrape the paper element away using dampened sandpaper of approximately 600 grit. A thin, elastic, film-like sheet having a motif formed thereon is produced as the image-receiving layer sheet (3) by means of this separation process.

Next, in step S3, the position to decoupage the abovementioned image-receiving layer sheet (3) on an object to be decorated is determined Any material may be acceptable as the object of the present embodiment for the decoupage method to be carried out thereon. For example, a material of choice, such as paper, leather, synthetic leather, wood, plastic, soap, metal, etc., is possible. Furthermore, the surface of the “object” of the present invention may also be curved.

Next, in step S4, the image-receiving layer sheet (3) is pasted onto the surface of a object. For pasting, first an aqueous glue of choice which is standardly used in decoupage is applied on the back side of the image-receiving sheet that was separated from the photographic printing paper, and the glue is dried (step S4-1). Then, the image-receiving sheet (3) is placed in a pre-determined position on a object, a Teflon® sheet is placed thereon, and heat is added from above with an iron, such that the glue which was applied on the back of the image-receiving sheet and dried in advance, is caused to soften and become adhesive. According to this method, since the water content of the glue has already been removed, quick adhesion not only to paper, wood, metal, etc. but strong adhesion to fabric is also possible.

Furthermore, since the image-receiving layer sheet (3) is relatively resistant to heat, even if heat around 100 degrees is applied, the formed image goes undisturbed. (However, since the ink from the image may burn and melt if a hot iron with a temperature of more than 100 degrees is applied to the surface of the image, setting the iron temperature below 120 degrees may be desirable.)

Since adhesive methods which utilize irons are superior for adhesion to fabrics, even when a handmade synthetic leather having an embedded photograph therein is created, the result is durable, such that the image portion does not peel off or lift off of the fabric when the fabric is folded.

Next, in step S5, a finish coating is performed. The coating can be done with a finish coating agent of choice that is standardly used in decoupage. However, the finish coating agent must be an aqueous coating agent. There are no particular procedure as to how many times the coating agent must to be applied, rather coating is performed as necessitated for the finished appearance. After coating, and after allowing the finish coating agent to dry, water-resistant paper may be used in order to integrate the decoupaged portion into the peripheral portions, and in order to remove uneven brushstrokes which were created in the application of the finish coating agent.

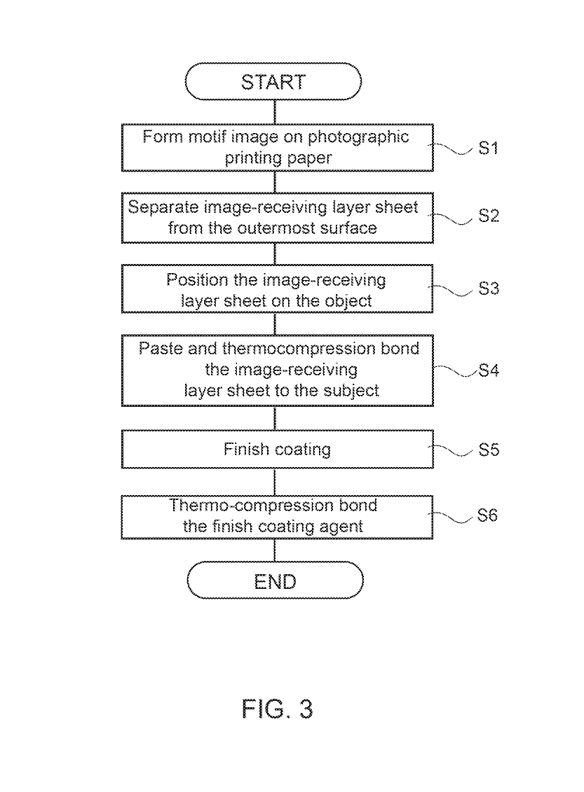

FIG. 3 is a flow-chart indicating another embodiment of this invention. This embodiment exemplifies applications for elastic materials other than fibrous materials such as fabric, in particular, using leather and synthetic leather as the object.

In this example, after the finish coating applied in step S5 is dried, further in step S6, an iron is applied to the coated surface of the image-receiving layer sheet (3) through a Teflon® sheet thereon so as to soften the coating agent, and carry out thermo-compression bonding on the image-receiving layer sheet (3).

In this example, as the finish coating used in step S5, it is ideal to use a vinyl acetate resin emulsion adhesive, or an ethylene vinyl acetate resin emulsion adhesive in which water dispersion has been adjusted to a consistency that can be applied to fabric. For example, Mod Podge®, which is manufactured for use on fibrous materials by Plaid Enterprises, Inc. in Norcross, Ga., USA, may be used.

In step S6, after hardening the finish coating agent, a Teflon® sheet is placed on the coated surface of the image-receiving layer sheet (3) so that direct contact with the iron is avoided. Furthermore, in order to avoid damaging the image-receiving layer sheet (3) or the object, heat and pressure are added in approximately two to three second intervals by uniformly ironing the entire surface, while observing the appearance. Since shape-conformity and the degree of adhesion between the coating agent, the image-receiving layer sheet (3) and the object improve through undergoing this process, even if a soft-curing type coating agent for fibrous materials such as fabrics is used, the adhesion and strength of the image-receiving layer sheet (3) increases dramatically. Accordingly, processing flexible materials other than fabric, such as leather and synthetic leather, is also possible using a soft-curing type coating agent meant for use fabrics.

Moreover, in the initially explained embodiment, step S4 has a thermo-compression bonding process which uses an iron, whereas in the embodiment indicated by FIG. 3, an additional thermo-compression bonding process is carried out in step S6. Conducting a similar thermo-compression bonding process in step S6, in addition to the thermo-compression bonding process of step S4, enables even greater results to be obtained when the object is leather or synthetic leather. It should be understood that even when the object is not leather or synthetic leather, a thermo-compression bonding process can be conducted two times or more, as shown in FIG. 3.

The above-explained method allows for obtaining the effect of resolving the problems of conventional decoupage motif photograph transfer methods, and dramatically improving the finished appearance and applicability.

Namely, although standard transfer methods are employed when extracting an photograph for use in decoupage from a photograph printed on normal photographic printing paper, in the method of this invention, an extremely thin film-like motif is able to be easily extracted without the use of a transfer solution. Accordingly, without using a transfer solution or special printing paper, anybody can easily transform a printed photograph in an album into a form suited for decoupage materials, and use the photograph as a decoupage material.

Therefore, the present invention is not limited to the above-mentioned embodiments such that, without changing the spirit of the present invention, various modifications are possible.

For example, after applying and drying glue on the back side of the image-receiving layer sheet (2), the application and drying of glue two times or more may be carried out. Furthermore, even stronger adhesion is achieved if glue is also applied and dried on the object side.

Furthermore, the above-mentioned finishing process is not limited only to mere glue coating. For example, in order to draw attention away from the borders of the image-receiving layer sheet (2) and the surrounding object, coloring such as acrylic paint or ink on the object and the surface of the image-receiving layer sheet (3) may be used. For example, when using a felt material as the object, a leather-like texture on the surface can be created by applying acrylic paint or ink to the object in accordance with the intended purpose, layering on a coating agent, and by stroking the surface with a brush before the coating agent dries. Moreover, after drying completely, moderate luster and strength can be increased by placing a Teflon® sheet on the surface and ironing with a sliding movement from above at a low temperature for approximately two seconds. After the object has cooled this process may be repeated as necessary.

Additionally, the material of the photographic printing paper (1) containing the image-receiving layer sheet (3) is not limited to the material in one of the above-mentioned embodiments, such that another material may be used so long as the purpose of the invention is achieved.

What is claimed is:

1. A decoupage method of transferring a motif to the surface of an object to decorate the object, the method comprising the steps of:
(a) printing a motif using sublimation thermal transfer printing on photographic printing paper having a thin-film image-receiving layer on the surface;
(b) separating only the thin-film image-receiving layer on which the motif is printed from the photographic printing paper as a thin-film image-receiving layer sheet;
(c) adhering the separated thin-film image-receiving layer sheet to the surface of an object; and
(d) finishing the surface of the object to which the thin-film image-receiving layer sheet is adhered.

2. The decoupage method of claim 1, wherein the thin-film image-receiving layer sheet comprises a thermoelastic polyester resin.

3. The decoupage method of claim 1, wherein the step (c) comprises:
applying a glue on the rear surface of the thin-film image-receiving layer sheet and drying the glue; and
positioning the thin-film image-receiving layer sheet in relation to the object to apply heat over the surface of the thin-film image-receiving layer sheet whereby the thin-film image-receiving layer sheet is closely pressed along the surface of the object to cause the glue to become viscous and adhere to the object.

4. The decoupage method of claim 1, wherein the object is a felt material, and wherein the step (d) comprises:
coloring the surface of the object to which the thin-film image-receiving layer sheet is adhered; and
forming an irregular texture on the surface of the object to which the thin-film image-receiving layer sheet is adhered;
whereby a synthetic leather-like texture is provided to the surface of the object.

5. The decoupage method of claim 1, wherein the object is leather or a synthetic leather material, and wherein the step (d) comprises:
coating the surface of the object to which the thin-film image-receiving layer sheet is adhered with a coating agent; and
after the coating agent is dried, placing a Teflon sheet on the coated surface of the object to apply heat and pressure by a thermo-pressure means to the coated surface through the Teflon sheet, whereby the coating agent is bonded to the object through thermo-compression bonding.

6. The decoupage method of claim 5, wherein the object includes a leather product or a synthetic leather product.
